(19) United States
(12) Patent Application Publication
(10) Pub. No.: US 2025/0124362 A1
(43) Pub. Date: Apr. 17, 2025

(54) SYSTEM AND METHOD FOR UTILIZING A CONVERSATION-BASED INTELLIGENT INTERFACE FOR MULTI-USER AUTOMATED ITINERARY COORDINATION

(71) Applicant: CELLIGENCE INTERNATIONAL LLC, Guaynabo, PR (US)

(72) Inventors: Pavan AGARWAL, DORADO, PR (US); Gabriel Albors SANCHEZ, SAN JUAN, PR (US); Jonathan Ortiz RIVERA, SAN JUAN, PR (US)

(73) Assignee: CELLIGENCE INTERNATIONAL LLC, Guaynabo, PR (US)

(21) Appl. No.: 18/986,604

(22) Filed: Dec. 18, 2024

Related U.S. Application Data
(63) Continuation-in-part of application No. 16/162,296, filed on Oct. 16, 2018.

(51) Int. Cl. G06Q 10/02; G06Q 50/14

(52) U.S. Cl. CPC G06Q 10/025; G06Q 50/14

(57) ABSTRACT

Systems and methods are provided for a conversation-based intelligent interface designed to facilitate the planning, booking, and dynamic management of multi-user travel itineraries. The system enables users to collaboratively establish travel schedules, coordinate travel logistics, and make real-time adjustments based on evolving conditions, leveraging user-specific preferences and payment methods. The system can dynamically respond to external factors (e.g., weather, traffic, or other disruptions), update reservations, and manage separate bookings based on individual requirements. The interface can also accommodate business travel policies, integrating expense management protocols for both personal and corporate expenses.

### RELATED APPLICATIONS

This application a continuation-in-part of U.S. patent application Ser. No. 16/162,296, filed on Oct. 16, 2018, the contents of which are incorporated herein by reference in its entirety.

### TECHNICAL FIELD

The present disclosure is generally related to trip planning. More particularly, the present disclosure is directed to systems and methods for generating reservation recommendations based on traveler information and trip plan information provided by traveler.

### BACKGROUND

Planning a trip can be complicated and require vising a plurality of travel operators to find, reserve, pay, and confirm services associated with a trip. Typically, flight reservations and hotel bookings are often only the start of it. Different platforms can be utilized by travelers seeking to plan a trip including receiving recommendations and reserving travel operators for multiple travel categories, including, airfare, accommodations, transportation, dining, and entertainment. Some of these platforms facilitate distributing reservation recommendations to travelers from certain operators merchants that meet a certain criteria provided by traveler, e.g., a budget.

### SUMMARY

In accordance with one or more embodiments, various features and functionality can be provided to enable or otherwise facilitate providing reservation recommendations based on traveler provided information. Embodiments disclosed herein relate to systems and methods for providing reservation recommendations related to trip planning information provided by traveler.

Travelers may utilize travel planning platforms that allow travelers to receive a set of reservation recommendations generated in response to a travel destination that a user is planning on visiting. The set of reservation recommendations may be generated based on traveler provided information and other information and available travel services provided by service vendors in one or more service category.

A reservation recommendation generated by a trip planning platform can be some form of a suggestion or advice for a particular travel reservation in a travel category, e.g., airfare, accommodations, transportation, dining, and entertainment selected from all of the reservations provided by service vendors. Recommendation may include preference indicators quantifying the booking likelihood estimate, which will be discussed in greater detail below.

A traveler may register and set up a traveler account with a trip planning platform. The traveler may input information associated with and/or relevant to the traveler via a traveler subscription component, such as traveler information specifying traveler demographic characteristics; travel preferences, activity and/or services the traveler may be interested in participating or receiving at a travel destination, by either specifying types or categories of activities or services, types of vendors delivering those activities and/or services, or both.

The traveler may plan a trip with the trip planning platform. The traveler may input trip planning information via a trip planning component for each trip the traveler may be planning. A reservation recommendation component may generate a number of reservation recommendations based on traveler information and trip planning information provided by the traveler via the traveler subscription component and the trip planning component respectively. The reservation recommendations may be generated using reservation information obtained from service a vendor. Reservation information may include reservations that meet criteria provided by the traveler such as a travel destination, a travel purpose, a budget, travel times and other similar information. The traveler may select all or some reservation recommendations generated by the recommendation component. A booking component may communicate the selections made by the traveler to the service vendor. The booking component may send traveler information provided by the traveler via the traveler subscription component to service vendor. Upon receiving the selections made by the traveler and traveler information from the booking component, the service vendor will reserve or book a corresponding reservation for the traveler.

A check-in component may receive geolocation information related to the traveler geographic location. The check-in component may determine that the traveler geographic location may be at or near the service vendor geographic location. Upon determining that the traveler geographic location is at or near the service vendor geographic location, the check-in component may communicate with the service vendor by sending a notification that the traveler is at the geographic location at or near that of the service vendor.

The system may manage traveler information to both provide the traveler with secure access to the trip planning platform and/or to expedite and facilitate the travel experience.

The traveler information inputted by the traveler may also include transportation information that is used to facilitate travel reservations. Additionally, the traveler may include accommodations information such as an accommodation type, accommodation rating preferences, room type preferences, preferences for restaurants within a hotel, and so on. The traveler may include entertainment information including types of recreational activities the traveler may be interested.

Further, the traveler may include preference and account information to facilitate automatic booking of air travel and other methods of transportation, accommodations, dining, and entertainment. Preference and account information provided by the traveler may include frequent flyer information for airline operators, reward program information for hotel and dining vendors and so on. The traveler may also include information regarding any special accommodations needs or requirement. The traveler may include information regarding emergency contacts.

In some embodiments, the traveler may input information related to the traveler account on one or more social media platforms via the traveler subscription component. The information related to traveler's social media platforms may include the traveler social network including the traveler friends.

Upon registering with the travel planning platform, the traveler may start using the trip planning platform by inputting trip planning information via a graphical user interface of trip planning trip platform. The trip planning information for each trip the traveler is planning on taking may be transmitted to trip planning component. Trip planning information may include one or more travel destination the traveler is planning on visiting during a timeframe indicated by the traveler.

In some implementations, rather than providing a destination and time frame information to the trip planning component, the traveler may enter information associated with an event the traveler is planning on attending. The travel planning component may determine a destination and time frame associated with the event based on event information provided by the traveler.

The traveler may provide one or more budgets associated with the trip. Additionally, the traveler may specify individual budgets for each of the categories of reservation recommendations.

Reservation recommendations provided to the traveler may be generated by the reservation recommendation component based on traveler information and trip information obtained by the trip planning platform. In particular, the reservation recommendation component may generate reservation recommendations based on traveler information received from the traveler subscription component and information received from the trip planning component. The reservation recommendation component may generate recommendations for each travel category associated with the trip being planned by the traveler based on provided travel destination, time frame and/or budget.

The reservation recommendations may be generated using reservation information obtained from the service vendor via the reservation recommendation component. Reservation information may include reservations that meet criteria provided by the traveler such as a travel destination, a travel purpose, a budget, travel times, and other similar information. The traveler may view reservation recommendations via a GUI on a mobile computing device The traveler may use the GUI to book reservation recommendations generated by the reservation recommendation component.

The reservation recommendations generated by the reservation recommendation component for each travel category of the trip may include reservations from one or more servicer vendors. In some embodiments, the reservation recommendation component may generate a single reservation recommendation based on a likelihood that reservation recommendation will be booked by the traveler. The reservation recommendation component may determine the booking likelihood of each of the reservation recommendation. The reservation recommendation component may analyze traveler information received from the traveler subscription component, and trip planning information received from the trip planning component in conjunction with one or more predictive models.

Further, the reservation recommendation component may provide multiple reservation recommendations for a given travel category. By providing multiple reservation recommendations for a given travel category, the traveler may compare multiple reservation recommendations and choose the most suitable one by booking a particular reservation recommendation via the booking component, discussed in more detail below. The reservation recommendation component may rank the generated recommendations by including a preference indicator associated with each reservation recommendation within a travel category.

The reservation recommendation component may include a preference indicator associated with individual reservation recommendations in accordance with traveler information and trip planning information.

Reservation recommendations provided to the traveler that have been generated by the reservation recommendation component may be selected by the traveler and booked via the booking component. Booking reservation recommendations associated with a given service vendor may include interfacing between the trip planning platform application programming interface (API) and the platform API associated with a service vendor platform providing the reservation information. The booking component may provide the service vendor platform traveler information including traveler's name, preferences, payment information to hold the reservation for the traveler.

The geolocation information corresponding to the geolocation of the traveler transmitted from a mobile computing device may be processed by the trip planning platform. In particular, the check-in component may be configured to notify service vendor that the traveler is in close proximity to the service vendor. The check-in component may transmit traveler information, including personal information, security information, payment information, to ensure that the traveler is seamlessly checked-in with the service vendor on traveler's itinerary.

In some embodiments, the trip planning platform may generate a notification transmitted from the trip planning platform via a wireless link and a communications network to mobile computing devices of one or more users identified by the traveler. The traveler may identify one or more users via the traveler subscription component to be notified of movements of the traveler. Accordingly, the geolocation of the traveler may be tracked in real-time by others. In some embodiments, the traveler may include location criteria that, if satisfied, would trigger a notification ton one or more users identified by the traveler. The notification transmitted to one or more users identified by the traveler may inform these users that the traveler has entered a geolocation that satisfied the location criteria provided by the traveler.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates conversation-based intelligent system for collaborative travel itinerary processing, in accordance with embodiments disclosed herein.

FIG. 2 illustrates an exemplary schematic diagram of a computer-based architecture of an exemplary apparatus of the conversation-based for collaborative travel itinerary processing system of FIG. 1, according to an implementation of the disclosure.

FIGS. 3-4 illustrate example user interfaces, in accordance with embodiments disclosed herein.

FIG. 5 is a flow chart illustrating various operations that may be utilized in providing reservation recommendations, in accordance with embodiments disclosed herein.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### DETAILED DESCRIPTION

The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

It should be noted that although the disclosure may describe embodiments in the context of a trip planning platform, reservation recommendations can be provided to travelers irrespective of how service vendors may provide the travel services, and/or any particular trip planning platform utilized by travelers.

Embodiments disclosed herein relate to systems and methods for providing reservation recommendations related to trip planning information provided by traveler.

A conversation-based intelligent system may include an interactive interface that enables two or more users to collaboratively establish a travel itinerary, with features allowing communication, availability matching, and preference sharing. The system may be integrated with external booking services (e.g., flights, hotels, transportation, dining, entertainment) to generate complete itineraries and process individual transactions upon user approval. Adaptive algorithms may be used to adjust and update the itinerary in real-time based on individual user conditions, location-based changes, and/or external disruptions. Finally, the system may include user-specific payment integration that allows secure transaction processing for individual expenses.

The conversation-based interface may be moderated by a software assistant for facilitating conversation among users to determine group travel objectives, overlapping availability for travel, automatically suggesting, booking, and confirming itinerary components (flights, accommodations, etc.) by using predictive algorithms and/or user-defined criteria. For example, the system may dynamically track the progress of each user's journey and modify itinerary elements based on user-specific changes (e.g., delayed flights, alternate travel arrangements, weather events) to ensure objectives of group travel are met and communicating updates to users and service providers (e.g., hotels, restaurants) based on real-time travel changes or disruptions. In some embodiment, the system may continuously monitor travel-related factors such as weather conditions, traffic updates, technical issues, natural disasters, or social unrest, to name a few, to determine propensity for potentially disruptive travel plans and adjusting the travel plans accordingly base do the determined propensity. The adjustment may include rescheduling of bookings, modifications to transport arrangements, and communication to all involved entities to ensure seamless adaptation of the itinerary.

In one embodiment, the system may be used for business group travel. For example, the system may allow users to establish itineraries based on corporate reimbursement policies by integrating payment protocols that differentiate corporate-covered expenses (e.g., flights) from individually covered ones (e.g., entertainment), with secure transaction handling and allowing users to manage both personal and corporate travel expenses through a single, unified interface.

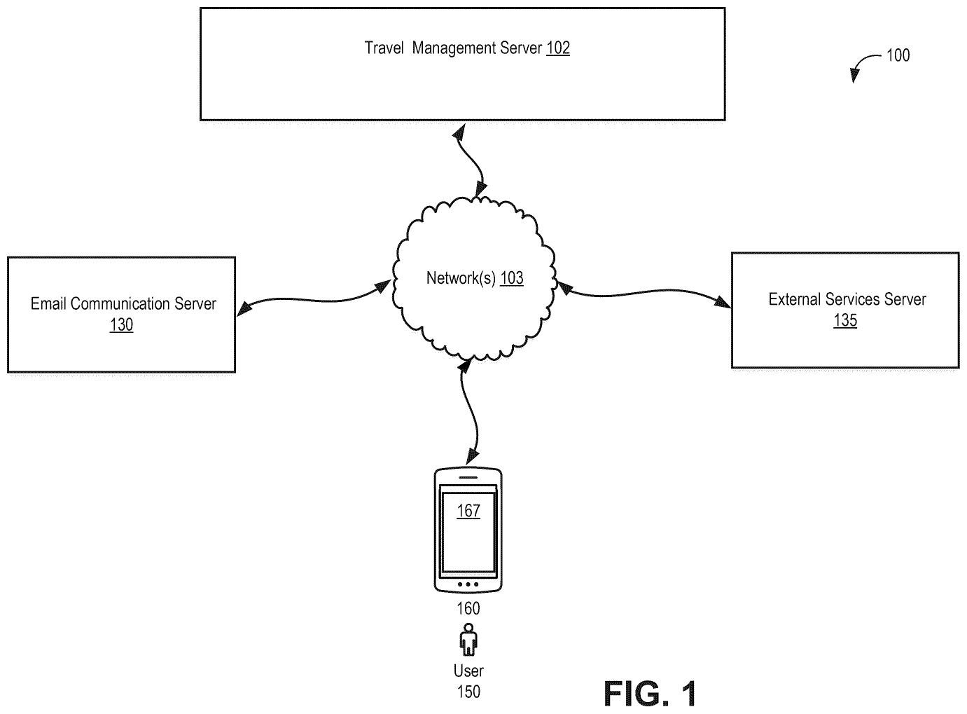

FIG. 1 illustrates an example trip planning system 100. Traveler 121 may register and set up a traveler account with trip planning platform 107. Traveler 121 may input information associated with and/or relevant to traveler 121 via traveler subscription component 109, such as traveler information specifying traveler demographic characteristics; travel preferences, activity and/or services traveler 121 may be interested in participating or receiving at a travel destination, by either specifying types or categories of activities or services, types of vendors delivering those activities and/or services, or both.

Traveler 121 may plan a trip with trip planning platform 107. Traveler 121 may input trip planning information via trip planning component 111 for each trip traveler 121 may be planning. Trip planning information may include one or more of a travel destination traveler 121 is planning on visiting, a travel purpose traveler 121 is planning on fulfilling when visiting the travel destination, a budget traveler 121 is designated for the trip, and travel times during which traveler 121 is planning on taking the trip. Traveler 121 may plan multiple trips with trip planning platform 107 by inputting trip planning information for each trip traveler 121 is planning on taking.

Reservation recommendation component 113 may generate a number of reservation recommendations based on traveler information and trip planning information provided by traveler 121 via traveler subscription component 109 and trip planning component 111 respectively. The reservation recommendations may be generated using reservation information obtained from service vendor 131. Reservation information may include reservations that meet criteria provided by traveler 121 such as a travel destination, a travel purpose, a budget, travel times and other similar information. Traveler 121 may select all or some reservation recommendations generated by recommendation component 113. Booking component 117 may communicate the selections made by traveler 121 to service vendor 131. Booking component 117 may send traveler information provided by traveler 121 via traveler subscription component 109 to service vendor 131. Upon receiving the selections made by traveler 121 and traveler information from booking component 117, service vendor will reserve or book a corresponding reservation for traveler 121.

Check-in component 119 may receive geolocation information related to traveler 121 geographic location. Check-in component 119 may determine that the traveler 121 geographic location may be at or near service vendor 131 geographic location. Upon determining that the traveler 121 geographic location is at or near service vendor 131 geographic location, check-in component 119 may communicate with service vendor 131 by sending a notification that traveler 121 is at the geographic location at or near that of service vendor 131.

In order for traveler 121 to have access to trip planning system 100, traveler 121 may provide varying levels of detail as part of both the subscription and subsequent modification processes. Any information not initially provided by traveler 121 can later be added to the traveler account. Information may be deleted as well. Traveler 121 may be required to provide some identification information for the traveler account. For example, traveler 121 trip planning platform 107 may generate a user name, password, pin, to be used for authenticating traveler 121 onto trip planning platform 107.

The traveler information inputted by traveler 121 may include personal information including details about traveler 121 such as demographic information including name, age, sex, race, address, telephone number, email, biometric information, and other personally identifiable information. Traveler 121 may provide payment information including credit card and/or debit card account information. Traveler 121 may also submit security information in order to obtain a higher traveler verification level resulting in a more seamless travel experience. For example, traveler 121 may provide such information as name, address, telephone number, email, credit card and/or debit card information, passport, driver's license, foreign travel documents (e.g., visas issued by foreign countries), images of traveler's face, retinal scan, fingerprints, facial scan, distinguishing marks, DNA, and so forth. Traveler subscription component 109 may handle traveler information inputted by traveler 121 either alone or in conjunction with database 105. For example, a user interface may be provided via traveler subscription component 109 allowing traveler 121 to input traveler information. The traveler information provided by traveler 121 via traveler subscription component 109 may be provided to recommendation component 117. Traveler information stored by database 105 may be encrypted.

System 100 may manage traveler information to both provide traveler 121 with secure access to trip planning platform 107 and/or to expedite and facilitate the travel experience. For example, personally identifiable information such as name and social security number may be used to verify identity of traveler 121 upon accessing system 100. Additionally, traveler information such as travel preferences and credit card and/or debit card account information, stored in database 105 may be used to facilitate and/or expedite reservation services that would otherwise require traveler 121 to provide large amounts of data for each transaction. Further, traveler information such as passport information or information is stored and usable by security personnel to expedite security clearances.

The traveler information inputted by traveler 121 may also include transportation information that is used to facilitate travel reservations. The travel preference information inputted by traveler 121 may further specify traveler 121 transportation preferences including types, categories and/or other such information related to each travel category, e.g., transportation, lodging, food, and entertainment. For example, traveler 121 may specify information air travel such as a desired class of air travel (e.g., coach, business class, or first class), a layover information (e.g., number of layovers, non-stop only), a preferred travel time, budget information (e.g., fare information), an airline carrier preference, seating preferences, meal preferences, parking preferences (e.g., self-park or valet parking), a desired departure airport preference, a preferred method of travel to or from the airport (e.g., self-drive, via a taxi or a transportation network company, via public transportation). Traveler 121 may include information regarding other transportation methods. For example, traveler 121 may specify preferred rental car companies, including vehicle preferences. Additionally, traveler 121 may specify, preferred transportation network company (e.g., Uber® or Lyft®), a transportation network company driver rating, a vehicle preference, and so on.

Additionally, traveler 121 may include accommodations information such as an accommodation type (e.g., boutique hotel, national chain hotel, online marketplace such as AirBnb®, etc.), accommodation rating preferences (e.g., user reviews, stars, diamonds, and other rating and/or ranking methods), room type preferences, preferences for restaurants within a hotel, and so on. Further, traveler 121 may include dining information including restaurant preferences, cuisine preferences, food sensitivities or allergies, restaurant location information (e.g., proximity to the hotel), and so on. Traveler 121 may include entertainment information including types of recreational activities traveler 121 may be interested in (e.g., outdoor adventures, family-friendly activities, theater, live music, and so on).

Further, traveler 121 may include preference and account information to facilitate automatic booking of air travel and other methods of transportation, accommodations, dining, and entertainment. Preference and account information provided by traveler 121 may include frequent flyer information for airline operators, reward program information for hotel and dining vendors and so on. Traveler 121 may also include information regarding any special accommodations needs or requirement (e.g., use of service animal, wheelchair, seasickness, other medical conditions, etc.). Traveler 121 may include information regarding emergency contacts (e.g., medical providers, family members, organ donor status and so on).

In some embodiments, traveler subscription component 109 may provide a set of questions to traveler 121 that may be used by reservation recommendation component 113 in determining what reservations are best suited for traveler 121. For example, in additional to traveler information already provided, traveler 121 may be asked to list the activities or types of activities they like to engage in, locations or types of locations they frequent, food and beverage preferences and/or aversions, and so on.

In some embodiments, traveler 121 may input information related to traveler 121 account on one or more social media platforms via traveler subscription component 109. For example, traveler 121 may have accounts with one or more social media platform such as Facebook® or Twitter®. The information related to traveler's social media platforms may include traveler 121 social network including traveler 121 friends. The information extracted from traveler 121 social media platform and may be extracted and stored in database 105.

Upon registering with travel planning platform 107, traveler 121 may start using trip planning platform 107 by inputting trip planning information via a graphical user interface of trip planning trip platform 107. The trip planning information for each trip traveler 121 is planning on taking may be transmitted to trip planning component 111. Trip planning information may include one or more travel destination traveler 121 is planning on visiting during a timeframe indicated by traveler 121. For example, traveler 121 may provide South Beach, Miami as a travel destination that traveler 121 is planning on visiting on May 5 through May 15. Traveler 121 may input a travel purpose for the trip. For example, the trip to South Beach, Miami may be taken for the purpose of attending a national orthopedic surgeon convention held at that time.

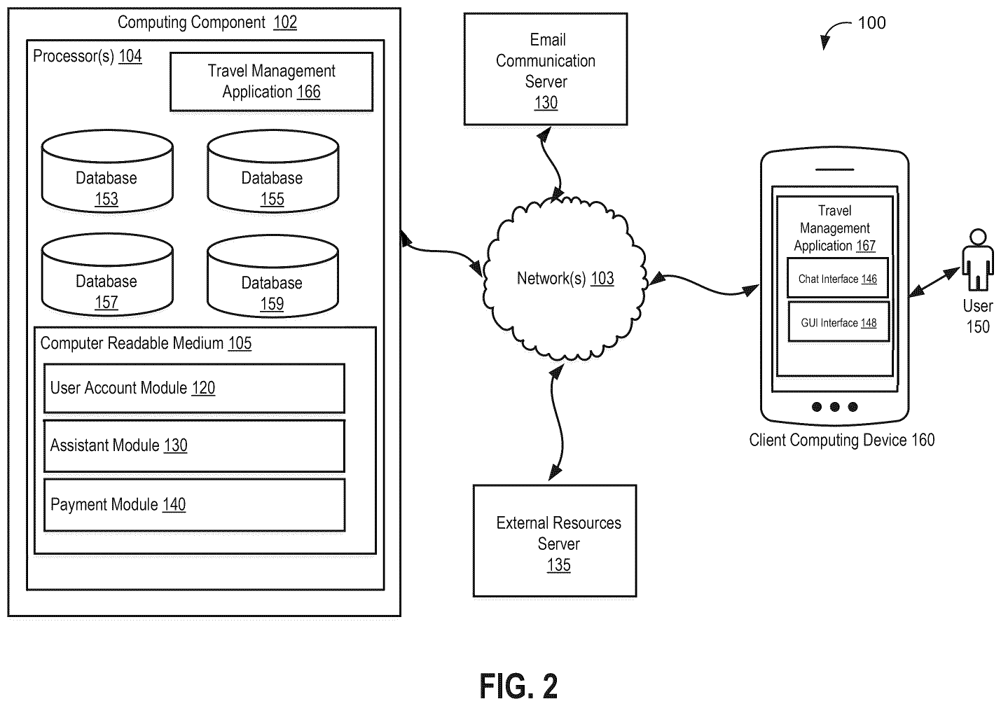

FIG. 2A, illustrates an example graphical user interface (“GUI”) 210. GUI 210 may be presented to one or more travelers, e.g., traveler 121, that have a traveler account on trip planning platform 107. Traveler 121 may access trip planning platform 107 via GUI 210 on a mobile computing device, identified as mobile computing device 125 in FIG. 1. GUI 210 may be implemented as part of a webpage “dashboard” and/or separate application accessible by traveler 121. In the context of this disclosure, a dashboard can refer to a collation of information about one or more trips traveler 121 is planning. Traveler 121 may create a trip by entering trip destination information and budget associated with the trip.

Referring back to FIG. 1, in some implementations, rather than providing a destination and time frame information to trip planning component 111, traveler 121 may enter information associated with an event traveler 121 is planning on attending. For example, traveler 121 may indicate that traveler 121 is planning on attending annual championship game of the National Football League (“Super Bowl”). Trip planning component 111 may determine a destination and time frame associated with the event based on event information provided by traveler 121. For example, trip planning component 111 may determine that the next Super Bowl game will be held in Atlanta, Georgia on Feb. 3, 2019.

Traveler 121 may provide one or more budgets associated with the trip. For example, traveler 121 may indicate that all reservation recommendations generated by reservation recommendation component 113 shall not exceed $5,000. Additionally, traveler 121 may specify individual budgets for each of the categories of reservation recommendations. For example, traveler 121 may specify that air fare costs shall not exceed $1,500, accommodation costs shall not exceed $2,000, transportation (including to and from the airport) costs shall not exceed $500, and food and entertainment costs shall not exceed $1,000.

In some embodiments, trip planning component 111 may determine a total budget associated with either the trip or individual budgets for each of the reservation recommendation categories based on budget information provided by traveler 121 via traveler subscription component 109. For example, traveler 121 may provide a $1,000 budget for air fare, a $2,000 budget for accommodations, a $1000 budget for transportation costs, and a $1,000 for food and entertainment. Based on the budget information provided by traveler 121 via traveler subscription component 109, trip planning component 111 may determine a total budget of $5,000 for the trip. Additionally, traveler 121 may provide individual budgets for each of the reservation recommendation categories associated with a type of trip (e.g., business or personal) traveler is planning on taking. For example, traveler 121 may provide a $2,000 budget for accommodations for personal trips and a $3,000 budget for accommodations for business trips. Trip planning component 111 may determine a total budget for the trip based on the purpose of the trip provided by traveler 121.

In some implementations, traveler 121 may provide an expense reimbursement policy including budgets for each of the reimbursable expense category associated with a company making a reimbursement. For example, traveler 121 may provide an expense reimbursement policy associated with traveler 121 employer. Upon indicating that traveler 121 is planning a work-related trip, trip planning component 111 may determine a total budget associated with either the trip or individual budgets for each of the reservation recommendation categories based on budget information obtained from the expense reimbursement policy. In some implementations, trip planning component 111 may obtain budget information based on historical information associated with prior trips taken by traveler 121, as will be discussed in greater detail below.

Trip planning information may include information on one or more additional travelers accompanying traveler 121 of the trip. Traveler 121 may plan a trip with additional travelers by inputting information related to one or more additional travelers that will be joining traveler 121 on the same trip. Traveler 121 may provide information related to additional travelers via traveler subscription component. For example, traveler 121 may provide information related to their family members including their preferences and needs. In some implementations, trip planning component 111 may suggest additional travelers based on information related to traveler 121 friends on one or more social network. For example, trip planning component 111 may determine that a friend is planning on going to the same event as traveler 121 based on information that friend provided on their social media platform. Trip planning component 111 may suggest adding friend to the trip traveler 121 is planning. By adding friends that are interested in going to the same destination or event, traveler 121 may reduce certain costs such as transportation costs.

Traveler 121 may provide trip planning information for multiple destinations within a single trip traveler 121 is planning on taking. For example, traveler 121 may be going to a sales meeting in Los Angeles for 3 days before going on a week-long family vacation to Disney World®. The trip planning information may include a purpose, a budget and number of additional travelers for the first leg of the trip (i.e., a sales meeting) that are different from the purpose, budget and number of additional travelers for the second leg of the trip (i.e., a family vacation). In some implementation, traveler may provide a single budget for multiple destinations associated with the trip. Traveler 121 may plan multiple trips with trip planning platform 107 by inputting trip planning information for each of the trips traveler 121 is planning on taking. For example, traveler 121 may be planning to attend a music festival in Chicago in August and going on a skiing trip in December.

Reservation recommendations provided to traveler 121 may be generated by reservation recommendation component 113 based on traveler information and trip information obtained by trip planning platform 107. In particular, reservation recommendation component 113 may generate reservation recommendations based on traveler information received from traveler subscription component 109 and information received from trip planning component 111. Reservation recommendation component 113 may generate recommendations for each travel category (e.g., transportation, lodging, food, and entertainment) associated with the trip being planned by traveler 121 based on provided travel destination, time frame and/or budget.

The reservation recommendations may be generated using reservation information obtained from service vendor 131 via reservation recommendation component 113. Reservation information may include reservations that meet criteria provided by traveler 121 such as a travel destination, a travel purpose, a budget, travel times, and other similar information. For example, traveler 121 may provide trip planning information via trip planning component 111 including a travel destination of Orlando, Florida, which traveler 121 wants to visit for a five-day family vacation with a budget of $10,000. Traveler 121 is including additional travelers on this trip including traveler's family members. Traveler information obtained by traveler subscription component 109 may include information that traveler 121 preferred airport for departures is John F. Kennedy International Airport, traveler 121 prefers direct flights only, and that traveler's family members include a spouse, a female child age ten and a male child age six. Traveler information may also include information that spouse of traveler 121 suffers from asthma and prefers non-smoking hotel rooms. Reservation recommendation component 113 may generate reservation recommendations including air fare recommendations for four people flying direct from JFK to MIA and returning to JFK, accommodations reservation recommendations for hotels near family-friendly attractions, transportation recommendations for rental cars, reservation recommendations for dinner, and entertainment reservation recommendations for amusement park tickets suitable for young children.

As illustrated in FIG. 2B, traveler 121 may view reservation recommendations via GUI 210 on a mobile computing device, identified as mobile computing device 125 in FIG. 1. Traveler 121 may use GUI to book reservation recommendations generated by reservation recommendation component 113 discussed in more detail below. Further, traveler 121 may use GUI to print information related to a reservation recommendation via print function 217 or discard a reservation recommendation via delete function 219.

Referring back to FIG. 1, the reservation recommendations generated by reservation recommendation component 113 for each travel category of the trip may include reservations from one or more servicer vendors, such as service vendor 131. In some embodiments, reservation recommendation component 113 may generate a single reservation recommendation based on a likelihood that reservation recommendation will be booked by traveler 121. Reservation recommendation component 113 may determine the booking likelihood of each of the reservation recommendation. Reservation recommendation component 113 may analyze traveler information received from traveler subscription component 109, and trip planning information received from trip planning component 111 in conjunction with one or more predictive models. The predictive models may include one or more of neural networks, Bayesian networks (e.g., Hidden Markov models), expert systems, decision trees, collections of decision trees, support vector machines, or other systems known in the art for addressing problems with large numbers of variables. Specific information analyzed during the recommendation generation may vary depending on the desired functionality of the particular predictive model.

Further, reservation recommendation component 113 may provide multiple reservation recommendations for a given travel category. By providing multiple reservation recommendations for a given travel category, traveler 121 may compare multiple reservation recommendations and choose the most suitable one by booking a particular reservation recommendation via booking component 117, discussed in more detail below. Reservation recommendation component 113 may rank the generated recommendations by including a preference indicator associated with each reservation recommendation within a travel category. For example, a reservation recommendation for airfare with a departure time of 8:00 AM may be ranked higher than a reservation recommendation for airfare with a departure time of 11 PM for traveler 121 traveling with small children.

Reservation recommendation component 113 may include a preference indicator associated with individual reservation recommendations in accordance with traveler information and trip planning information. The preference indicator may be a sliding scale of percentile values (e.g., 10%, 15%, . . . n, where a percentage may reflect a degree of preference), numerical values (e.g., 1, 2, . . . n, where a number may be assigned as low and/or high), verbal levels (e.g., very low, low, medium, high, very high, and/or other verbal levels), and/or any other scheme to represent a preference score.

Reservation recommendation component 113 may determine each recommendation preference by utilizing a variety of analytical techniques to analyze collected sets of merchant information and traveler information to generate a preference indicator. For example, reservation recommendation component 113 may utilize Bayesian-type statistical analysis to determine the preference indicator for each recommendation. The preference indicator may be a quantified likelihood of a traveler being satisfied with a recommendation.

Reservation recommendations provided to traveler 121 that have been generated by reservation recommendation component 113 may be selected by traveler 121 and booked via booking component 117. Booking reservation recommendations associated with a given service vendor may include interfacing between the trip planning platform application programming interface (API) and the platform API associated with a service vendor platform providing the reservation information. Booking component 117 may provide the service vendor platform traveler information including traveler's name, preferences, payment information to hold the reservation for traveler 121. As illustrated in FIG. 2B, traveler 121 may select reservation recommendations via GUI 210 on a mobile computing device, identified as mobile computing device 125 in FIG. 1. Upon successfully “booking” (i.e., communicating traveler's name, preferences, payment information associated with traveler 121 to service vendor platform and receiving a confirmation form the service vendor platform) a reservation recommendation, GUI will reflect that the reservation is paid.

Mobile computing device 125 of traveler 121 may be equipped with GPS location tracking and may transmit geolocation information via a wireless link and a communications network to trip planning platform 107 of system 100. Trip planning platform 107 may use the geolocation information to determine a geolocation of traveler 121. System 100 may use signal transmitted by mobile computing device 125 to determine the geolocation of traveler 121 based on one or more of signal strength, GPS, cell tower triangulation, Wi-Fi location, or other input. In some implementations, movements of traveler 121 may be tracked using a geography-based transmitter on mobile computing device 125.

In some implementations, traveler 121 may be traveling in a motor vehicle or other means of transportation. Accordingly, trip planning platform 107 may obtain geolocation information comprising of a direction of travel and/or speed with which traveler 121 is traveling. Further still, in some implementations, trip planning platform 107 may obtain the geolocation information directly from traveler 121. For example, trip planning platform 107 may request traveler 121 to provide a street address or enter other location identifying attributes, such as prominent landmarks.

The geolocation information corresponding to the geolocation of traveler 121 transmitted from mobile computing device 125 may be processed by trip planning platform 107. In particular, check-in component 119 may be configured to notify service vendor that traveler 121 is in close proximity to the service vendor. For example, upon traveler 121 arriving at an airport, check-in component 119 may notify a transportation service that traveler is ready to be picked up. Similarly, upon traveler approaching a hotel, check-in component 119 may notify a hotel that traveler 121 is checking-in. Check-in component 119 may transmit traveler information, including personal information, security information, payment information, to ensure that traveler 121 is seamlessly checked-in with the service vendor on traveler's itinerary.

In some embodiments, trip planning platform 107 may generate a notification transmitted from trip planning platform 107 via a wireless link and a communications network to mobile computing devices of one or more users identified by traveler 121. Traveler 121 may identify one or more users via traveler subscription component 109 to be notified of movements of traveler 121. For example, as traveler 121 moves from one location to another, traveler 121 family members may receiving notification including traveler 121 geolocation. Accordingly, the geolocation of traveler 121 may be tracked in real-time by others. In some embodiments, traveler 121 may include location criteria that, if satisfied, would trigger a notification ton one or more users identified by traveler 121. The notification transmitted to one or more users identified by traveler 121 may inform these users that traveler 121 has entered a geolocation that satisfied the location criteria provided by traveler 121.

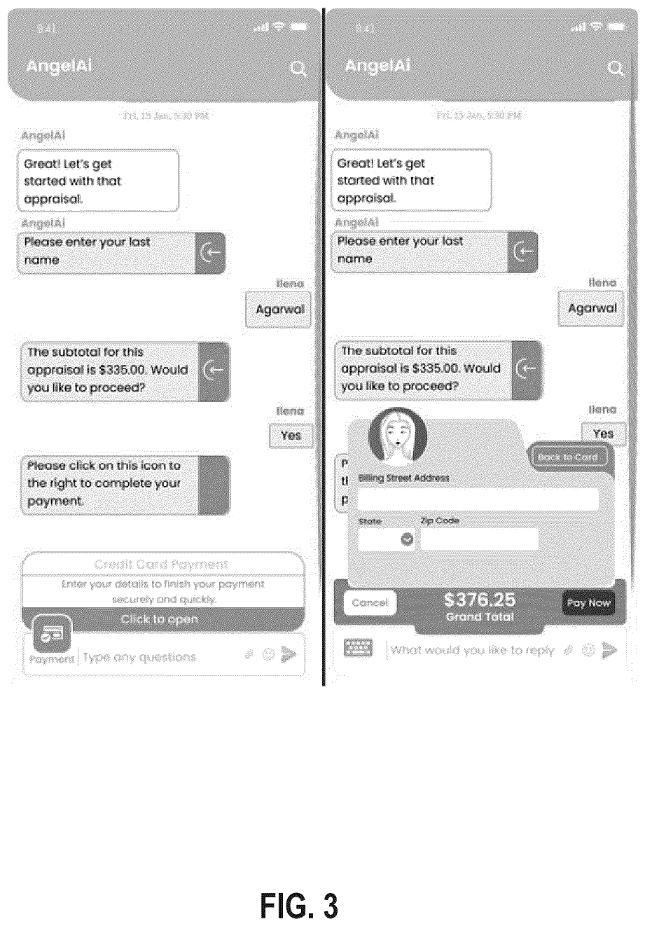

FIG. 3 illustrates an example computing component that may be used to implement various features of the system and methods disclosed herein, for example, trip planning platform 107, server 103, traveler subscription component 109, trip planning component 111, reservation recommendation component 113, booking component 117, check-in component 119, and/or one or more elements comprising these components.

As used herein, the term component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. In implementation, the various components described herein might be implemented as discrete components or the functions and features described can be shared in part or in total among one or more components. In other words, as would be apparent to one of ordinary skill in the art after reading this disclosure, the various features and functionality described herein may be implemented in any given application and can be implemented in one or more separate or shared components in various combinations and permutations. Even though various features or elements of functionality may be individually described or claimed as separate components, one of ordinary skill in the art will understand that these features and functionality can be shared among one or more common software and hardware elements, and such description shall not require or imply that separate hardware or software components are used to implement such features or functionality.

Where components are implemented in whole or in part using software, in one embodiment, these software elements can be implemented to operate with a computing or processing component capable of carrying out the functionality described with respect thereto. One such example computing component is shown in FIG. 3. Various embodiments may be described in terms of this example computing component 300. After reading this disclosure, it will become apparent to a person skilled in the relevant art how to implement the application using other computing components or architectures.

Computing component 300 may represent, for example, computing or processing capabilities found within a desktop, laptop, notebook, and tablet computers; hand-held computing devices (tablets, PDA's, smart phones, cell phones, palmtops, etc.); workstations or other devices with displays; servers; or any other type of special-purpose or general-purpose computing devices as may be desirable or appropriate for a given application or environment. Computing component 300 might also represent computing capabilities embedded within or otherwise available to a given device. For example, a computing component might be found in other electronic devices such as, for example, portable computing devices, and other electronic devices that might include some form of processing capability.

Computing component 300 might include, for example, one or more processors, controllers, control components, or other processing devices, such as a processor 304. Processor 304 might be implemented using a general-purpose or special-purpose processing engine such as, for example, a microprocessor, controller, or other control logic. In the illustrated example, processor 36 is connected to a bus 302, although any communication medium can be used to facilitate interaction with other components of computing component 300 or to communicate externally.

Computing component 300 might include one or more memory components, simply referred to herein as memory 38. For example, preferably random access memory (RAM) or other dynamic memory, might be used for storing information and instructions to be executed by processor 304. Memory 308 might be used for storing temporary variables or other intermediate information during execution of instructions, such as machine-readable instructions, to be executed by processor 304. Computing component 300 might include a read only memory (“ROM”) or other static storage device coupled to bus 302 for storing static information and instructions for processor 304.

The computing component 300 might include one or more various forms of information storage mechanisms 310, which might include, for example, a media drive 312. The media drive 312 might include a drive or other mechanism to support fixed or removable storage media 314. For example, a hard disk drive, a solid-state drive, a magnetic tape drive, an optical disk drive, a compact disc (CD) or digital video disc (DVD) drive (R or RW), or other removable or fixed media drive might be provided. Accordingly, storage media 44 might include, for example, a hard disk, an integrated circuit assembly, magnetic tape, cartridge, optical disk, a CD or DVD, or other fixed or removable medium that is read by, written to or accessed by media drive 312. As these examples illustrate, the storage media 314 can include a computer usable storage medium having stored therein computer software or data.

Computing component 300 might include other similar instrumentalities for allowing computer programs or other instructions or data to be loaded into computing component 300. Such instrumentalities might include, for example, a fixed or removable storage unit 322 and an interface 320. Examples of such storage units 322 and interfaces 320 can include a program cartridge and cartridge interface, a removable memory (for example, a flash memory or other removable memory component) and memory slot, a PCMCIA slot and card, and other fixed or removable storage units 322 and interfaces 320 that allow software and data to be transferred from the storage unit 322 to computing component 300.

Computing component 300 might include a communications interface 324. Communications interface 324 might be used to allow software and data to be transferred between computing component 300 and external devices. Examples of communications interface 324 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 324 might typically be carried on signals, which can be electronic, electromagnetic (which includes optical) or other signals capable of being exchanged by a given communications interface 324. These signals might be provided to communications interface 324 via a channel 328. This channel 328 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 308, storage unit 322, media 314, and channel 328. These and other various forms of computer program media or computer usable media may be involved in carrying one or more sequences of one or more instructions to a processing device for execution. Such instructions embodied on the medium, are generally referred to as “machine-readable code,” “computer program code” or a “computer program product” (which may be grouped in the form of computer programs or other groupings). When executed, such instructions might enable the computing component 32 to perform features or functions of the disclosure as discussed herein.

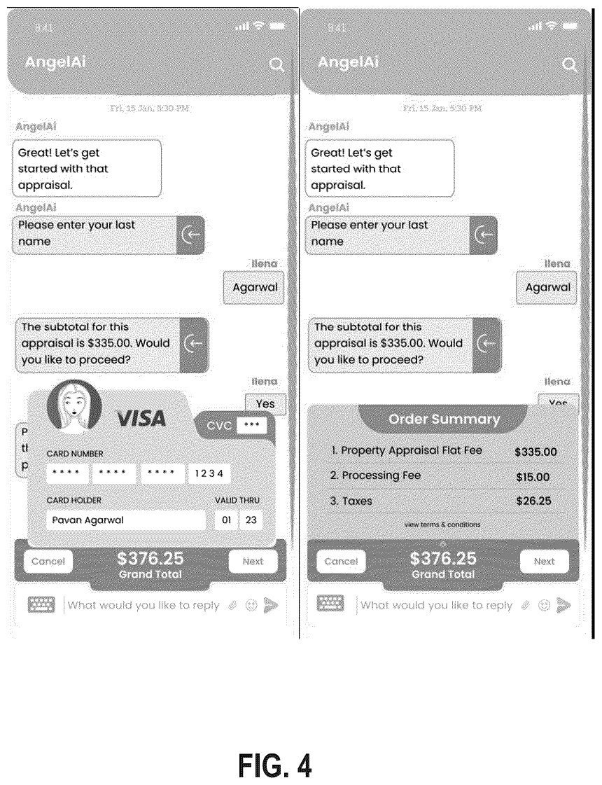

FIG. 4 illustrates elements that may make up reservation recommendation component 113, booking component 117, checking-in component 119, and database 105. The elements in FIG. 4 are described in conjunction with each other and in the context of system 100 (see FIG. 1) for ease of explanation.

Database 105 may include traveler database 407. Traveler information reflecting information characterizing one or more aspects of a traveler may be stored in traveler database 407. Traveler 121 may be one such traveler. Upon registering with trip planning platform 107, traveler 121 may input certain traveler information including personal information such as demographic information including name, age, sex, race, address, telephone number, email, biometric information, and other personally identifiable information. Traveler 121 can include payment information such as credit card and/or debit card account information. Traveler 121 may include security information such as name, address, telephone number, email, credit card and/or debit card information, passport, driver's license, foreign travel documents (e.g., visas issued by foreign countries), images of traveler's face, retinal scan, fingerprints, facial scan, distinguishing marks, DNA. Traveler 121 can include special accommodation information such as special needs or requirement (e.g., use of service animal, wheelchair, seasickness, other medical conditions, etc.).

Traveler 121 can include transportation information, accommodations information, dining information, entertainment information, and other travel preference information inputted by traveler 121. Traveler preference information may specify traveler 121 travel preferences including types, categories and/or other such information related to each travel category, e.g., transportation, lodging, food, and entertainment.

Database 105 may include traveler trip planning information database 409. Traveler trip planning information reflecting information for each trip traveler 121 is planning on taking such as one or more travel destination traveler 121 is planning on visiting during a timeframe indicated by traveler 121, a travel purpose, an event traveler 121 is planning on attending, one or more budgets associated with the trip, and information on one or more additional travelers accompanying traveler 121 of the trip. Trip planning information may be stored in traveler database 409. Traveler 121 may provide access to one or more social platforms upon registering with trip planning platform 107.

The records maintained traveler trip planning information database 409 (which can be thought of as current data) can be transferred to traveler historical information database 411. Traveler historical information database 411 can include information which indicates the types of trips traveler 121 has planned including reservation recommendations accepted by traveler 121.

Database 105 may include service vendor database 415. Service vendor information reflecting information related to one or more service vendors and reservation information including reservations offered by the one or more service vendors may be stored in service vendor database 415.

Reservation recommendation component 113 may comprise reservation recommendation engine 413 for generating reservation recommendations, booking engine 417 for transmitting the reservation recommendations and other related information (e.g., traveler information and traveler trip information historical information and historical use information) to a service vendor (such as service vendor 131 of FIG. 1) upon traveler 121 accepting a reservation recommendation, and check-in engine 419 for transmitting notifications including traveler 121 location information to the service vendor and/or other users specified by traveler 121.

Reservation recommendation engine 413 may be configured to determine reservation information provided by service vendor 131 that meets the criteria specified by traveler information and trip planning information. For example, reservation recommendation engine 413 may obtain reservation information which reflects flights offered by service vendor 131 to a destination specified by traveler 121.

Reservation recommendation engine 413 may obtain service vendor information, e.g., details related to a service vendor; reservation information specifying reservations available for specific service vendor merchant products and/or services from service vendor database 415.

Reservation recommendation engine 413 may obtain traveler information reflecting information characterizing one or more aspects of traveler 121 including traveler personal information, payment information, security information, transportation information accommodations information, dining information, entertainment information travel preference information, and traveler social media information related to traveler's social media accounts on one or more social media platforms, from one or more of databases 407-411. For example, reservation recommendation engine 413 may obtain traveler information from traveler database 407, which can provide preferences for services travelers may be interested in. Reservation recommendation engine 413 may obtain traveler trip information from traveler trip planning information database 409. Reservation recommendation engine 413 may obtain traveler historical information associated with the traveler form traveler historical database 411.

Reservation recommendation engine 413 can compare traveler information specifying details about the traveler and traveler preference information specifying preferences related to services a traveler may be interested in (e.g., traveler information from traveler database 407), traveler trip planning information specifying destination, budget, and time related to a trip traveler is planning on taking (e.g., traveler trip planning information associated with the traveler form traveler trip planning information database 409) and previously accepted reservation recommendations by the traveler (e.g., historical information associated with the traveler form traveler historical information database 411) with reservations service vendor 131 wishes to offer travelers (e.g., reservation information from service vendor database 415) to determine whether a reservation provided by service vendor 131 should be recommended to traveler 121.

Such recommendations can be determined from an overall traveler perspective, e.g., by comparing traveler preferences and trip planning information with reservations provided by a merchant, or a more granular perspective, i.e., whether or not a traveler has shown a preference that was not indicated directly by the traveler but rather one that can be obtained by analyzing historical traveler information. For example, traveler historical information can be correlated to traveler information and/or traveler trip planning information. That is, reservation recommendation engine 413 may determine whether or not the reservation recommendation is beneficial to traveler 121. For example, reservation recommendation engine 413 may determine that reservation recommendations for air travel with an evening departure time should not be recommended to a traveler planning to take a trip with his two young children despite the fact that traveler has not indicated that they dislike evening departures.

Reservation recommendation engine 413 may forward the aforementioned reservation recommendations to one or more travelers and/or trip planning platform 107. Reservation recommendation engine 413 may present recommendations as selectable options via some user interface accessible by traveler 121. Traveler 121 may accept one or more reservations presented by reservation recommendation engine 413.

Reservation recommendation engine 413 may forward the accepted reservations to booking engine 417 to notify service vendors and/or trip planning platform 107 that traveler 121 wishes to reserve and/or purchase the reservation.

Booking engine 417 may forward one or more reserved or purchased reservations to check-in engine 419. Check-in engine 419 may notify one or more service vendors and/or other users specified by traveler 121 of traveler's geographic location upon determining that traveler is at or near geographic location associated with the service vendor (e.g., a hotel) or with location where services are requested (e.g., an Uber® pick up location). Check-in engine 419 may forward traveler information, payment information, security and/or other information to further facilitate the trip. By notifying the services vendors that traveler 121 is at or near the location, service vendors may use the traveler information, payment information, security and/or other information to ensure that that traveler the services are ready to be rendered (e.g., traveler is check-ed in to the hotel) thus removing the requirement for traveler to interact directly with the service vendors.

It should be noted that recommendations themselves may be tiered, where recommendations may be generated and presented to traveler 121 in terms of estimated value levels. For example, a first set of recommendations may be generated and presented to traveler 121, where this first set may be predicted to bring value to traveler 121 at a level of, e.g., 95 percent. A second set of recommendations may be generated and presented to traveler 121, where this second set may include less valuable recommendations. This second set of recommendations may be predicted to bring value to traveler 121 at a level of, e.g., 20 percent. Depending, for example, on the value level desirable to traveler 121, traveler 121 may select an appropriate recommendation set.

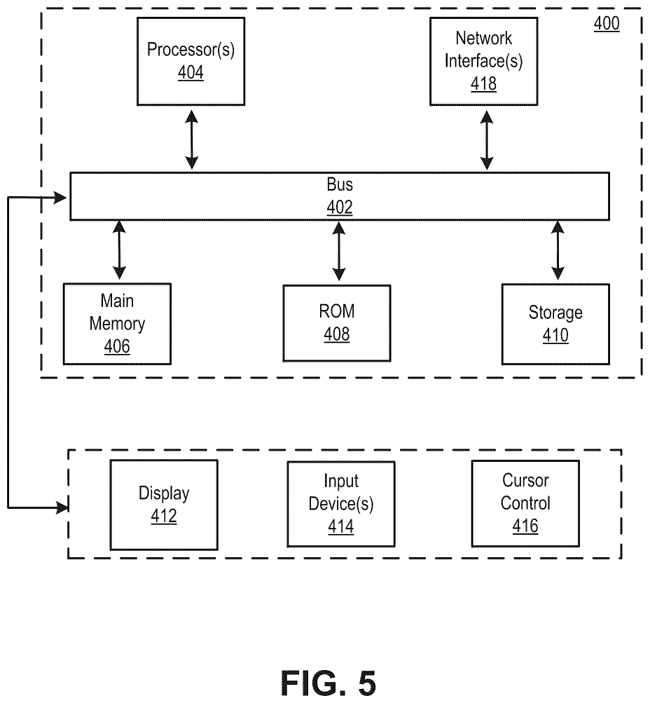

FIG. 5, illustrates a flow chart describing various processes that can be performed in order to provide recommendations in accordance with one embodiment. At operation 505, traveler information associated with a traveler is obtained. As described previously, traveler information may comprise data characterizing one or more aspects of traveler including traveler personal information, payment information, security information, transportation information accommodations information, dining information, entertainment information travel preference information, and traveler social media information related to traveler's social media accounts on one or more social media platforms. At operation 510, traveler trip information associated with a trip traveler is planning on taking is obtained. Further, at operation 510, traveler historical information reflecting past trips traveler has taken is obtained. At operation 515, a set of reservations from the service vendor of the type specified by traveler trip information may be obtained. At operation 520, the traveler information associated with the traveler, traveler trip information, traveler historical information, and a set of reservations from each service vendor may be correlated. For example, a budget that may be applicable to the traveler can be determined from current or historical data. At operation 525, reservation recommendations can be generated based on the correlations between the traveler information associated with a traveler, traveler trip information, and traveler historical information with the set of reservations from each service vendor.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method of generating a travel plan based on user travel destination in a client application, the method comprising:
obtaining user information, the user information including demographic information of a user and preference information of the user, such that the demographic information indicating demographic characteristics of the user and the preference information indicating at least one preference for at least one travel category;
obtaining destination information, the destination information indicating a travel destination of the user;
obtaining travel information associated with one or more service providers, the one or more service providers providing at least one of a transportation, accommodation, dining, or entertainment services at or near the travel destination of the user, the travel information including one or more travel recommendations, wherein individual travel recommendations comprising a start time and an end time;
determining one or more reservation recommendations comprising the one or more travel recommendations by analyzing the one or more travel recommendations associated with the one or more service providers and the at least one preference for the at least one travel category;
ordering the one or more reservation recommendations based on a time line order, such that a start time of a second reservation recommendation would begin after an end time of a first reservation recommendation, wherein the time line order specifying a sequence in which the user will be using the services associated with the one or more service providers;
generating a set of user travel recommendations based on the ordered one or more reservation recommendations, the set of user travel recommendations representing a subset of the of the reservation recommendations; and
presenting the set of user travel recommendations within a graphical interface of an application.

2. The method of claim 1, further comprising determining a set of value estimates for each of the user travel recommendations within the set of user travel recommendations.

3. The method of claim 2, wherein the set of value estimates for each of the user travel recommendations within the set of user travel recommendations is determined based on at least the preference information.

4. The method of claim 2, further comprising ordering each of the user travel recommendations within the set of user travel recommendations, such that each of the user travel recommendations is ordered based on an order specified by the set of value estimates, wherein individual user travel reservations that have a determined higher value estimate are given a higher order number than the individual user travel reservations that do not.

5. The method of claim 1, further comprising generating a notification comprising the set of user travel recommendations.

6. The method of claim 1, wherein the user information includes historical trip information, wherein determining the one or more reservation recommendations is based on analyzing the one or more travel recommendations and the historical trip information.

7. The method of claim 6, wherein the destination information includes budget information, the budget information inciting a budget associated with the travel destination of the user.

8. The method of claim 1, wherein the user information includes payment information.

9. The method of claim 8, further comprising transmitting the payment information to the one or more service providers associated with the one or more travel recommendations corresponding to individual user travel recommendations within the set of user travel recommendations accepted by the user.

10. The method of claim 9, further comprising obtaining a payment acceptance confirmation from the one or more service providers associated with the one or more travel recommendations corresponding to the individual user travel recommendations within the set of user travel recommendations for which the payment information has been transmitted.

11. A system configured to generate a travel plan based on user travel destination in a client application, the system comprising:
one or more physical processors configured by machine-readable instructions to:
obtain user information, the user information including demographic information of a user and preference information of the user, such that the demographic information indicating demographic characteristics of the user and the preference information indicating at least one preference for at least one travel category;
obtain destination information, the destination information indicating a travel destination of the user;
obtain travel information associated with one or more service providers, the one or more service providers providing at least one of a transportation, accommodation, dining, or entertainment services at or near the travel destination of the user, the travel information including one or more travel recommendations, wherein individual travel recommendations comprising a start time and an end time;
determine at least one or more reservation recommendations comprising the one or more travel recommendations by analyzing the one or more travel recommendations associated with the one or more service providers and the at least one preference for the at least one travel category;
order the at least one or more reservation recommendations based on a time line order, such that a start time of a second reservation recommendation would begin after an end time of a first reservation recommendation, wherein the time line order specifying a sequence in which the user will be using the services associated with the one or more service providers;
generate a set of user travel recommendations based on the ordered one or more reservation recommendations, the set of user travel recommendations representing a subset of the of the reservation recommendations; and
present the set of user travel recommendations within a graphical interface of an application.

12. The system of claim 11, wherein the one or more physical processors are further configured by machine-readable instructions to determine a set of value estimates for each of the user travel recommendations within the set of user travel recommendations.

13. The system of claim 12, wherein the set of value estimates for each of the user travel recommendations within the set of user travel recommendations is determined based on at least the preference information.

14. The system of claim 12, wherein the one or more physical processors are further configured by machine-readable instructions to:
order each of the user travel recommendations within the set of user travel recommendations, such that each of the user travel recommendations is ordered based on an order specified by the set of value estimates, wherein individual user travel reservations that have a determined higher value estimate are given a higher order number than the individual user travel reservations that do not.

15. The system of claim 11, wherein the one or more physical processors are further configured by machine-readable instructions to generate a notification comprising the set of user travel recommendations.

16. The system of claim 11, wherein the user information includes historical trip information.

17. The system of claim 16, wherein the one or more physical processors are further configured by machine-readable instructions to determine the at least one or more reservation recommendations is based on analyzing the one or more travel recommendations and the historical trip information.

18. The system of claim 17, wherein the user information includes payment information.

19. The system of claim 18, wherein the one or more physical processors are further configured by machine-readable instructions to transmit the payment information to the one or more service providers associated with the at least one or more travel recommendations corresponding to individual user travel recommendations within the set of user travel recommendations accepted by the user.

20. The system of claim 18, wherein the one or more physical processors are further configured by machine-readable instructions to obtain a payment acceptance confirmation from the one or more service providers associated with the at least one or more travel recommendations corresponding to the individual user travel recommendations within the set of user travel recommendations for which the payment information has been transmitted.
